(19) United States
(12) Patent Application Publication
(10) Pub. No.: US 2010/0059572 A1
(43) Pub. Date: Mar. 11, 2010

(54) WELD REPAIR PROCESS AND ARTICLE REPAIRED THEREBY

(75) Inventors: John M. Sassatelli, Valley Falls, NY (US); John F. Nolan, Scotia, NY (US); Nicholas D. Porteous, Atlanta, GA (US); Mark J. Passino, JR., East Greenbush, NY (US); Gerald R. Crawmer, Clifton Park, NY (US); Carter S. Cook, Westford, NY (US)

Correspondence Address: GE ENERGY GENERAL ELECTRIC;C/O ERNEST G. CUSICK, ONE RIVER ROAD, BLD. 43, ROOM 225, SCHENECTADY, NY, 12345, US

(73) Assignee: GENERAL ELECTRIC COMPANY

(21) Appl. No.: 12/206,886

(22) Filed: Sep. 9, 2008

(51) Int. Cl. B23K 31/02

(52) U.S. Cl. 228/119

(57) ABSTRACT

A method for repairing a steel alloy article, and an article repaired thereby, is provided and comprises the steps of depositing at least a first weld repair layer on a surface of the article so as to form a heat affected zone in the article beneath the surface. Locally heat treating the first weld repair layer and at least a portion of the heat affected zone adjacent the first weld repair layer at a temperature above the critical A₁ temperature of the steel alloy article. Depositing at least one additional weld repair layer on the first weld repair layer without forming additional heat affected zone in the surface of the article. The first weld repair layer and the at least one additional weld repair layer are comprised of a material chosen from the group consisting of nickel chromium—iron alloys, cobalt base alloys, ERNiCr-3, ENiCrFe-3, ERNiCrMo-3, ERNiFeCr-2, ERCoCr-A, ERCoCr-E, CrMo alloys and CrMoV alloys. The article can be placed in service without a post-weld heat treatment of the additional weld repair layer following the step of depositing the additional weld repair layer.

### BACKGROUND OF THE INVENTION

The present invention relates to welding processes. More particularly, this invention relates to a method for weld repairing a steel alloy article, the method entailing a localized heat treatment technique that is applied to a limited intermediate region of the weld repair prior to completion of the weld repair, and avoids a full post-weld heat treatment of the article.

Chromium-molybdenum (CrMo) and chromium-molybdenum vanadinun (CrMoV) low-alloy steels have found wide use for components of steam turbines and other power plant applications. These alloys have been selected in part on the basis of creep and fatigue properties due to the severe operating conditions of steam turbine components. Although steam turbine components made from CrMo and CrMoV steels exhibit a long service life, it is possible that wear, erosion, corrosion, shock, fatigue and/or overstress will occur, necessitating repair or replacement of the component. In the past, repairs of CrMo and CrMoV components have often been performed by welding, in which the damaged portion of the component is removed and a steel weldment is built up in its place. After repair, the component has traditionally undergone a postweld heat treatment (PWHT) in order to relieve stresses induced by the weld repair process and to temper the hardened weld heat-affected zone (HAZ), thereby developing properties similar to that of the original alloy.

Comparative hardness data for as-welded and post-weld heat treated CrMoV alloy is shown in FIG. 2. Hardness is measured within the HAZ of the weld region, where the chemical composition of the base alloy is generally unchanged by the welding operation but considerable microstructural change has occurred as a result of the severe thermal cycle that takes place during welding. One effect of this microstructural change is that considerable hardening occurs within the HAZ. In FIG. 2, hardness is indicated within the HAZ relative to the distance from the fusion line, defined here as the interface between the weld repair material and the base material of the component. Because weld-induced hardness is detrimental to creep and fatigue properties, FIG. 2 evidences that post-weld heat treatment is needed to promote these desirable properties in a weld-repaired component.

In the past, post-weld heat treatment has entailed heating the entire component to a temperature below the critical temperature “A₁” of the alloy, which is defined in the art as the lower limit of the face-centered cubic lattice crystallographic structure (austenite) of the iron-carbon equilibrium diagram. A drawback to this process is the cost of the heat treatment operation, the time involved to perform the operation, and the possibility of distorting the component. These drawbacks are particularly problematic in the repair of high-temperature components that have heightened creep resistance requirements, such as the CrMoV turbine lower shell of a steam turbine. Removal of these components for post-weld heat treatment is costly and time-consuming due to piping connections that must be cut and rewelded, realignment of the turbine after repair, etc. However, repair of such components without a post-weld heat treatment generally yields unsuitable results, and attempts at in-situ post-weld heat treatment have a tendency to distort the shell.

Consequently, weld repair techniques have been proposed using filler materials that do not require post-weld heat treatment. However, such techniques are generally limited to temporary repairs and some noncritical applications, because weld repairs that undergo post-weld heat treatment generally exhibit superior properties. Other alternatives for making weld repairs without post-weld heat treatment include various temperbead welding techniques, in which a carefully controlled welding sequence provides some degree of tempering by superimposing a suitable temperature region of the HAZ from the weld bead being deposited on a hard portion of a HAZ from a previously deposited weld bead. Such techniques have been performed in an attempt to provide beneficial softening of hard metallurgical structures in the HAZ. However, when applied to some CrMo and CrMoV alloy steel components, undesirable HAZ hardening has been found, as evidenced by the data scatterband for temperbead techniques shown in FIG. 2.

### BRIEF SUMMARY OF THE INVENTION

According to one aspect of the present invention, a method for repairing a steel alloy article, is provided and comprises the steps of depositing at least a first weld repair layer on a surface of the article so as to form a heat affected zone in the article beneath the surface. Locally heat treating the first weld repair layer and at least a portion of the heat affected zone adjacent the first weld repair layer at a temperature above the critical A₁ temperature of the steel alloy article. Depositing at least one additional weld repair layer on the first weld repair layer without forming additional heat affected zone in the surface of the article. The first weld repair layer and the at least one additional weld repair layer are comprised of a material chosen from the group consisting of nickel chromium—iron alloys, cobalt base alloys, ERNiCr-3, ENiCrFe-3, ERNiCrMo-3, ERNiFeCr-2, ERCoCr-A, ERCoCr-E, CrMo alloys and CrMoV alloys. The article can be placed in service without a post-weld heat treatment of the additional weld repair layer following the step of depositing the additional weld repair layer.

According to another aspect of the present invention, a method for repairing a low-alloy steel article is provided. The method comprising the steps of removing a surface portion of the article so as to define a base surface of the article. Depositing at least one weld repair layer on the base surface so as to form a first weld repair on the base surface and a heat affected zone in the article beneath the base surface, the first weld repair being a nickel chromium iron alloy and having a thickness of about four to about eight millimeters. Locally heat treating the first weld repair and at least a portion of the heat affected zone adjacent the first weld repair at a temperature of about 1500° F. to about 1600° F. Depositing a fill weld layer on the first weld repair without forming additional heat affected zone in the base surface, the fill weld layer comprised of a material chosen from the group consisting of nickel chromium iron alloys, cobalt base alloys, ERNiCr-3, ENiCrFe-3, ERNiCrMo-3, ERNiFeCr-2, ERCoCr-A, ERCoCr-E, CrMo alloys and CrMoV alloys. The article can then subsequently be placed in service without a post-weld heat treatment of the fill weld layer following the step of depositing the fill weld layer.

According to yet another aspect of the present invention, an article is provided that is repaired by a method comprising the steps of depositing at least a first weld repair layer on a surface of the article so as to form a heat-affected zone in the article beneath the surface, the first weld repair layer being formed of a nickel chromium iron alloy. Locally heat treating the first weld repair layer and the heat-affected zone at a temperature above the critical A₁ temperature of the article, the heat treating step reducing the hardness of the first weld repair layer and at least a portion of the heat-affected zone. Depositing at least one additional weld repair layer on the first weld repair layer without forming additional heat-affected zone beneath the surface of the article, the additional weld repair layer comprised of a material chosen from the group consisting of nickel chromium iron alloys, cobalt base alloys, ERNiCr-3, ENiCrFe-3, ERNiCrMo-3, ERNiFeCr-2, ERCoCr-A, ERCoCr-E, CrMo alloys and CrMoV alloys. The article includes the heat-affected zone beneath the surface of the article, the first weld repair layer on the surface of the article, and the at least one additional weld repair layer overlying the first weld repair layer, the at least one additional weld repair layer being in an as-welded condition without a post-weld heat treatment so as to be harder than the first weld repair layer.

### BRIEF DESCRIPTION OF THE DRAWINGS

FIG. 1 represents a cross-section of a weld repair formed in accordance with this invention;

FIG. 2 is a graph representing hardness variations within the HAZ of a weld repair region in a low-alloy steel repaired in accordance with the prior art;

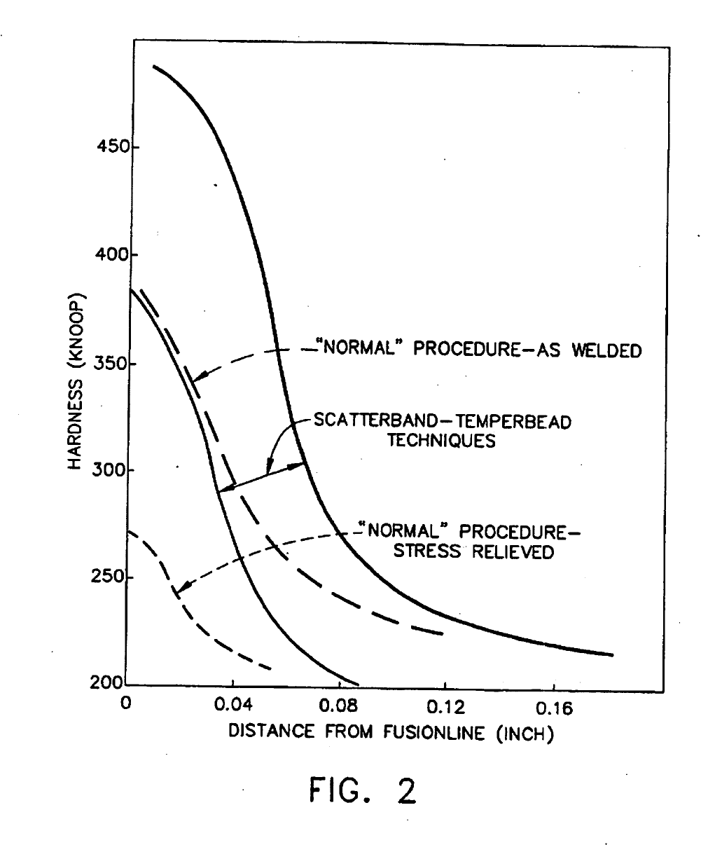

FIG. 3 is a graph representing comparative low-cycle fatigue data for a low-alloy steel repaired in accordance with this invention and the same low-alloy steel repaired in accordance with the prior art.

### DETAILED DESCRIPTION OF THE INVENTION

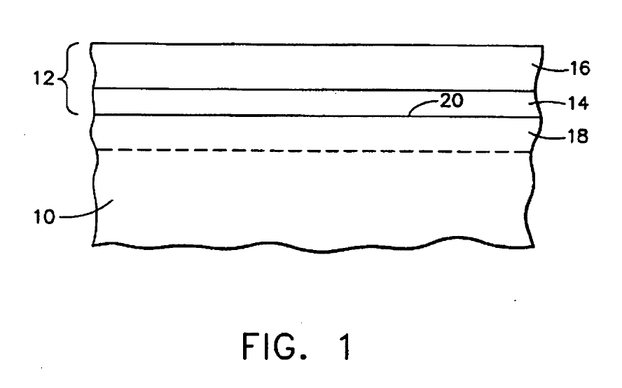

FIG. 1 represents in cross-section a low-alloy steel article that has been repaired in accordance with this invention. An example of such an article is a component of a steam turbine, though a wide variety of components could be repaired by the method of this invention. As represented in FIG. 1, the article generally includes a base material 10 on which a weld repair 12 has been built up to restore the article to its original dimensions after a damaged portion has been removed. The weld repair 12 generally includes one or more weld repair layers that have been deposited on the surface of the base material 10 to yield a surfacing weld repair 14. In turn, a fill weld layer 16 is shown as having been deposited on the surfacing weld repair 14. The interface between the surfacing weld repair 14 and the base material 10 is termed the fusion line 20 of the weld repair 12. According to this invention, when repairing CrMoV and CrMo alloys of the type used to form steam turbine components, an example of which is 1.25Cr-1Mo-0.25V (in weight percent), suitable materials for the weld repair 14 and weld layer 16 include CrMo, CrMoV and NiCrFe alloys. A particularly suitable nickel chromium iron alloy is NiCrFe-3. Other alloys, filler metals or weld electrodes could also be used such as, but not limited to, Inconel® (a registered trademark of the Special Metals group of companies) alloys 82 (ERNiCr-3), 182 (ENiCrFe-3), 625 (ERNiCrMo-3), 718 (ERNiFeCr-2), cobalt base alloys, Stellite® (a registered trademark of the Deloro Stellite Company) 6 (SFA 5.21 ERCoCr-A), Stellite® 21 ((SF)A 5.21 ERCoCr-E). According to the invention, the low carbon content for the repair alloys has been found to be particularly important for achieving acceptable as-welded high temperature properties.

During the investigation leading to this invention, the occurrence of undesirable hardening of the HAZ produced by temperbead techniques performed on CrMoV steels was determined to be a result of the secondary hardening characteristic of such steels, evidencing that the retention time at a sufficient tempering temperature is of too short a duration. As a solution to this problem, the present invention is based on the determination that local heat treatment applied to a limited portion of the weld immediately adjacent the base material 10 can provide sufficient retention time to improve the properties of the HAZ 18 in the base material 10. Tests employing temperatures above the critical temperature “A₁” of the base material alloy have shown dramatic improvement over tests employing conventional stress-relief temperatures, i.e., post-weld heat treatments performed below the A₁ temperature of the base material alloy.

The preferred method for repairing a low-alloy steel article in accordance with this invention generally entails completely removing the damaged portion of the article. The surfacing weld repair 14 is then formed by depositing one or more weld layers on the newly-exposed surface of the base material 10 using a suitable welding technique, such as a shielded metal arc welding (SMAW), though it is foreseeable that other techniques could be employed. The process of depositing the surfacing weld repair 14 on the base material 10 produces the HAZ 18 shown in FIG. 1. For the repair of a CrMo or CrMoV alloy, such as 1.25Cr-1Mo-0.25V, a suitable material for the surfacing weld repair 14 is a NiCrFe alloy, and particularly the above-noted NiCrFe-3 alloy.

The total thickness of the surfacing weld repair 14 is selected such that local heat treatment of the weld repair 14 and the underlying HAZ 18 can be readily accomplished, yet the subsequently deposited fill weld layer 16 will not produce additional HAZ in the base material 10. A localized heat treatment is then performed on the weld repair 14 and the HAZ 18. For a CrMo or CrMoV alloy, the critical temperature A₁ is about 1370° F. (about 745° C.). Therefore, according to this invention the heat treatment is performed at a temperature of at least about 1420° F. (about 770° C.), and preferably between about 1500° F. (about 815° C.) and about 1600° F. (about 870° C.). A suitable duration for this heat treatment step is up to about fifteen minutes, though longer durations are foreseeable. In this temperature range, a suitable thickness for the surfacing weld repair 14 is about four to about eight millimeters.

Metallographic examination of the repaired region at this stage of the process has shown that the surfacing weld repair 14 and the HAZ 18 are preferably characterized by a hardness of not higher than about 365 Knoop and a grain size of not larger than about ASTM 6. Following heat treatment, the fill weld layer 16 can be deposited using conventional welding techniques, such as shielded metal arc welding. For the repair of CrMo and CrMoV alloys, the above-noted NiCrFe-3 alloy has been found advantageous for this purpose.

During the investigation of this invention, the repair method described above was performed on cast 1.25CrlMo-0.25V alloy specimens. A surfacing weld repair 14 of the above-noted low carbon 0.5Cr-1Mo alloy was deposited on each specimen using a shielded metal arc welding electrode to produce a HAZ 18 in the surface of the specimen. The surfacing weld repair 14 and the underlying HAZ 18 were then locally torch heated to a temperature of about 1500° F. to about 1600° F. i.e., above the critical A₁ temperature of about 1400° F. (about 760° C.) for the steel, for a duration of about five to ten minutes. Subsequent metallographic examination of the specimens revealed that the former HAZ 18 and surfacing weld repair 14 were entirely replaced with a fine-grain structure with acceptable hardness properties, generally a hardness of not greater than about 365 Knoop. A weld repair 12 was then completed by forming a fill weld layer 16 of the NiCrFe-3 alloy using the same shielded metal arc welding technique used to deposit the surfacing weld repair 14. In accordance with this invention, the fill weld layer 16 did not undergo any post-weld heat treatment, and therefore remained in the as-welded condition.

Specimens were then randomly selected to undergo creep rupture testing at temperatures ranging from about 1050° F. to about 1200° F. (about 565° C. to about 650° C.), and at loads corresponding to rupture at Larson-Miller parameter values of about 33.6 to about 36.6. The results of this test were that the creep properties of the specimens were found to be comparable to cast 1.25Cr-1Mo-0.25V alloy specimens that are repaired by the conventional method using a 0.5Cr-1Mo weld filler alloy and then subjected to a full post-weld heat treatment below the critical temperature A₁ of the alloy.

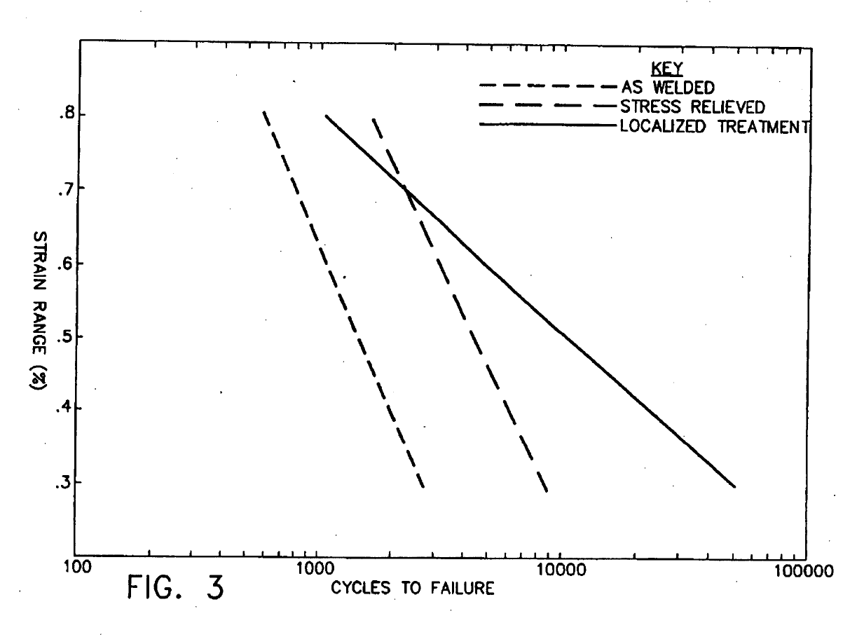

Other specimens were subjected to low-cycle fatigue testing at about 1050° F. (about 565° C.), with complete strain reversal and no hold time. For comparison, two sets of specimens were prepared using the conventional weld repair method with a conventional 0.5Cr-1Mo filler metal (i.e., having a carbon content of about 0.07 to about 0.15 weight percent), one set with and the second without a full post-weld heat treatment. The results of this test are represented in FIG. 3, which evidences that specimens prepared using the conventional weld repair method with full post-weld heat treatment performed significantly better than those repaired conventionally but without the post-weld heat treatment. Most notably, those specimens processed in accordance with this invention exhibited low-cycle fatigue resistance comparable to or better than the conventionally-processed specimens with post-weld heat treatment, as indicated in FIG. 3.

From the above, it was concluded that reliable repairs were achieved with the repair process of this invention, and that low-alloy steel components repaired according to this invention can be expected to exhibit service lives that are comparable to low-alloy steel components conventionally repaired with a conventional full post-weld heat treatment.

In addition, the selection of the weld preparation geometry is such that the higher creep and rupture properties of the dissimilar weld can be placed into a region of stress concentration in the part for improved remaining life when compared to conventional matching alloy repair methods.

While the invention has been described in connection with what is presently considered to be one of the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A method for repairing a steel alloy article, the method comprising the steps of:
depositing at least a first weld repair layer on a surface of the article so as to form a heat affected zone in the article beneath the surface;
locally heat treating the first weld repair layer and at least a portion of the heat affected zone adjacent the first weld repair layer at a temperature above the critical A₁ temperature of the steel alloy article;
depositing at least one additional weld repair layer on the first weld repair layer without forming additional heat affected zone in the surface of the article;
wherein, the first weld repair layer and the at least one additional weld repair layer are comprised of a material chosen from the group consisting of nickel chromium—iron alloys, cobalt base alloys, ERNiCr-3, ENiCrFe-3, ERNiCrMo-3, ERNiFeCr-2. ERCoCr-A, ERCoCr-E, CrMo alloys and CrMoV alloys; and
placing the article in service without a post-weld heat treatment of the additional weld repair layer following the step of depositing the additional weld repair layer.

2. A method as recited in claim 1, wherein the first weld repair layer is a NiCrFe-3 alloy.

3. A method as recited in claim 1, wherein the additional weld repair layer is a NiCrFe-3 alloy.

4. A method as recited in claim 1, wherein the first weld repair layer and the additional weld repair layer are formed of a NiCrFe-3 alloy.

5. A method as recited in claim 1, wherein the locally heat treating step is performed for up to about fifteen minutes.

6. A method as recited in claim 1, wherein the first weld repair layer and the heat affected zone have a grain size of not larger than about ASTM 6 after the heat treatment step.

7. A method as recited in claim 1, wherein the first weld repair layer and the heat affected zone have a hardness of not higher than about 365 Knoop after the heat treatment step.

8. A method as recited in claim 1, wherein each of the depositing steps entails a shielded metal arc welding technique.

9. A method as recited in claim 1, wherein the article is a component of a steam turbine.

10. A method for repairing a low-alloy steel article, the method comprising the steps of:
removing a surface portion of the article so as to define a base surface of the article;
depositing at least one weld repair layer on the base surface so as to form a first weld repair on the base surface and a heat affected zone in the article beneath the base surface, the first weld repair being a nickel chromium iron alloy and having a thickness of about four to about eight millimeters;
locally heat treating the first weld repair and at least a portion of the heat affected zone adjacent the first weld repair at a temperature of about 1500° F. to about 1600° F.;
depositing a fill weld layer on the first weld repair without forming additional heat affected zone in the base surface, the fill weld layer comprised of a material chosen from the group consisting of nickel chromium iron alloys, cobalt base alloys, ERNiCr-3, ENiCrFe-3, ERNiCrMo-3, ERNiFeCr-2, ERCoCr-A. ERCoCr-E, CrMo alloys and CrMoV alloys; and
subsequently placing the article in service without a post-weld heat treatment of the fill weld layer following the step of depositing the fill weld layer.

11. A method as recited in claim 10, wherein the first weld repair and the fill weld layer are a NiCrFe-3 alloy.

12. A method as recited in claim 10, wherein the first weld layer and the heat affected zone have a grain size of not larger than about ASTM 6 after the heat treatment step.

13. A method as recited in claim 10, wherein the first weld layer and the heat affected zone have a hardness of not higher than about 365 Knoop after the heat treatment step.

14. A method as recited in claim 10, wherein each of the depositing steps entails a shielded metal arc welding technique.

15. A method as recited in claim 10, wherein the article is a component of a steam turbine.

16. An article repaired by a method comprising the steps of:
depositing at least a first weld repair layer on a surface of the article so as to form a heat-affected zone in the article beneath the surface, the first weld repair layer being formed of a nickel chromium iron alloy;
locally heat treating the first weld repair layer and the heat-affected zone at a temperature above the critical A₁ temperature of the article, the heat treating step reducing the hardness of the first weld repair layer and at least a portion of the heat-affected zone; and then;
depositing at least one additional weld repair layer on the first weld repair layer without forming additional heat-affected zone beneath the surface of the article, the additional weld repair layer comprised of a material chosen from the group consisting of nickel chromium iron alloys, cobalt base alloys, ERNiCr-3, ENiCrFe-3. ERNiCrMo-3, ERNiFeCr-2, ERCoCr-A, ERCoCr-E, CrMo alloys and CrMoV alloys;
wherein the article comprises the heat-affected zone beneath the surface of the article, the first weld repair layer on the surface of the article, and the at least one additional weld repair layer overlying the first weld repair layer, the at least one additional weld repair layer being in an as-welded condition without a post-weld heat treatment so as to be harder than the first weld repair layer.

17. An article according to claim 16, wherein the article is formed of a NiCrFe-3 alloy.

18. An article according to claim 16, wherein the article is a component of a steam turbine.
